(19) United States
(12) Patent Application Publication
(10) Pub. No.: US 2026/0119430 A1
(43) Pub. Date: Apr. 30, 2026

(54) HIGH-EFFICIENCY MAINBAND TRAINING FLOW FOR UNIVERSAL CHIPLET INTERCONNECT EXPRESS

(71) Applicant: MEDIATEK INC., Hsinchu City (TW)

(72) Inventors: Chih-Lun Chuang, Hsinchu City (TW); Yi-Ting Lin, Hsinchu City (TW); Po-Chun Kuo, Hsinchu City (TW); Yu-Chieh Chen, Hsinchu City (TW)

(73) Assignee: MEDIATEK INC., Hsinchu City (TW)

(21) Appl. No.: 19/372,296

(22) Filed: Oct. 29, 2025

Related U.S. Application Data
(60) Provisional application No. 63/713,072, filed on Oct. 29, 2024.

(51) Int. Cl. G06F 13/38

(52) U.S. Cl. CPC G06F 13/382; G06F 2213/38

(57) ABSTRACT

The present invention provides a mainband training method between a transmitter within a first die and a receiver within a second die, wherein the mainband training method comprises the steps of: setting, by the receiver, a valid framing criteria and a valid signal pass criteria, wherein the valid framing criteria is more lenient than the valid signal pass criteria; receiving, by the receiver, a valid signal from the transmitter, and determining if the valid signal satisfies the valid framing criteria; and if the valid signal satisfies the valid framing criteria, identifying, by the receiver, centers of eye opening of multiple data signal and the valid signal.

### CROSS REFERENCE TO RELATED APPLICATIONS

This application claims the benefit of U.S. Provisional Application No. 63/713,072, filed on October 29th, 2024. The content of the application is incorporated herein by reference.

### BACKGROUND

As the demand for higher bandwidth, lower latency, and improved power efficiency in computing systems continues to grow, the ability to effectively integrate diverse chiplets from various vendors onto a single package has become paramount. Traditional monolithic integrated circuit designs are increasingly facing limitations in terms of cost, manufacturing complexity, and design flexibility, particularly for highly specialized functions. This has led to a paradigm shift towards heterogeneous integration, where specialized chiplets are interconnected to form a complete system. However, the lack of a standardized, open interface for chiplet-to-chiplet communication has been a significant barrier to widespread adoption.

The Universal Chiplet Interconnect Express (UCIe) standard, developed by the UCIe Consortium, addresses this critical need by providing an open, industry-standard specification for die-to-die interfaces chiplet. UCIe defines a complete stack, encompassing the physical layer (PHY), the die-to-die adapter layer, and the protocol layer, enabling seamless communication between chiplets regardless of their fabrication process or vendor. The standard supports both standard packaging and advanced packaging technologies, offering flexibility and scalability for a wide range of applications, from high-performance computing to automotive and mobile devices. A key aspect of UCIe is its emphasis on robust and reliable communication. This is achieved through sophisticated training mechanisms designed to optimize signal integrity across the die-to-die interconnect. These training sequences are crucial for compensating for channel impairments such as impedance mismatches, reflections, crosstalk, and process variations, thereby ensuring reliable data transfer at high speeds. The mainband training flow is a fundamental part of this process, establishing optimal operating conditions for data transmission.

The mainband training flow in the UCIe standard involves a series of steps to calibrate and optimize the communication link between two chiplets. These operations are essential for establishing robust and high-fidelity signal transmission. The main operations of mainband training flow include “VALTRAIN CENTER”, “VALTRAIN VREF”, “DATATRAIN CENTER” and “DATATRAIN CENTER”, wherein “VALTRAIN CENTER” focuses on identifying the center of the eye opening of valid signal, “VALTRAIN VREF” aims to optimize the reference voltage for sampling the valid signal, “DATATRAIN CENTER” focuses on identifying the center of the eye opening of data signal, “DATATRAIN VREF” aims to optimize the reference voltage for sampling the data signal. Because the four operations above are performed sequentially, this can lead to issues with efficiency or quality. Specifically, during the operation of “VALTRAIN CENTER”, all data and track transmitters are held low during valid-to-clock training, so signal integrity (SI) is not at its worst-case scenario. During the operation of “VALTRAIN VREF”, all data and track transmitters are held low during valid-to-clock training, so signal integrity (SI) is not at its worst-case scenario, and additional time is required for reference voltage calibration. During the operation of “DATATRAIN CENTER”, a linear feedback shift register (LFSR) pattern on data must be accompanied by correct valid framing on the valid lane. During the operation of “DATATRAIN VREF”, a LFSR pattern on data must be accompanied by correct valid framing on the valid lane, and the receiver cannot ascertain the pass window for every data lane.

### SUMMARY

Therefore, one object of the present invention is to provide a mainband training flow that offers shorter calibration time and improved signal integrity, thereby addressing the problems in the prior art.

According to one embodiment of the present invention, a mainband training method between a transmitter within a first die and a receiver within a second die comprises the steps of: setting, by the receiver, a valid framing criteria and a valid signal pass criteria, wherein the valid framing criteria is more lenient than the valid signal pass criteria; receiving, by the receiver, a valid signal from the transmitter, and determining if the valid signal satisfies the valid framing criteria; and if the valid signal satisfies the valid framing criteria, identifying, by the receiver, centers of eye opening of multiple data signal and the valid signal.

According to one embodiment of the present invention, a package comprising first die and a second die is disclosed. The first die comprises a transmitter, and the second die comprises a receiver, wherein the first die and the second die performs a mainband training method, and the mainband training method comprises: setting, by the receiver, a valid framing criteria and a valid signal pass criteria, wherein the valid framing criteria is more lenient than the valid signal pass criteria; receiving, by the receiver, a valid signal from the transmitter, and determining if the valid signal satisfies the valid framing criteria; and if the valid signal satisfies the valid framing criteria, identifying, by the receiver, centers of eye opening of multiple data signal and the valid signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a package according to one embodiment of the present invention.

FIG. 2 shows a flowchart of the mainband training flow of two dies according to one embodiment of the present invention.

FIG. 3 is a diagram showing valid framing criteria and valid signal pass criteria.

FIG. 4 is a diagram illustrating using a binary search-like method to determine a center of eye opening of valid signal.

FIG. 5 is a diagram of determine centers of eye opening of multiple data signals and valid signal according to one embodiment of the present invention.

FIG. 6 is a diagram illustrating a receiver initiated data to clock eye width sweep operation according to one embodiment of the present invention.

FIG. 7 is a diagram illustrating LFSR clear error request with PI information including signal bit and delay line code.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to …”. The terms “couple” and “couples” are intended to mean either an indirect or a direct electrical connection. Thus, if a first device couples to a second device, that connection may be through a direct electrical connection, or through an indirect electrical connection via other devices and connections.

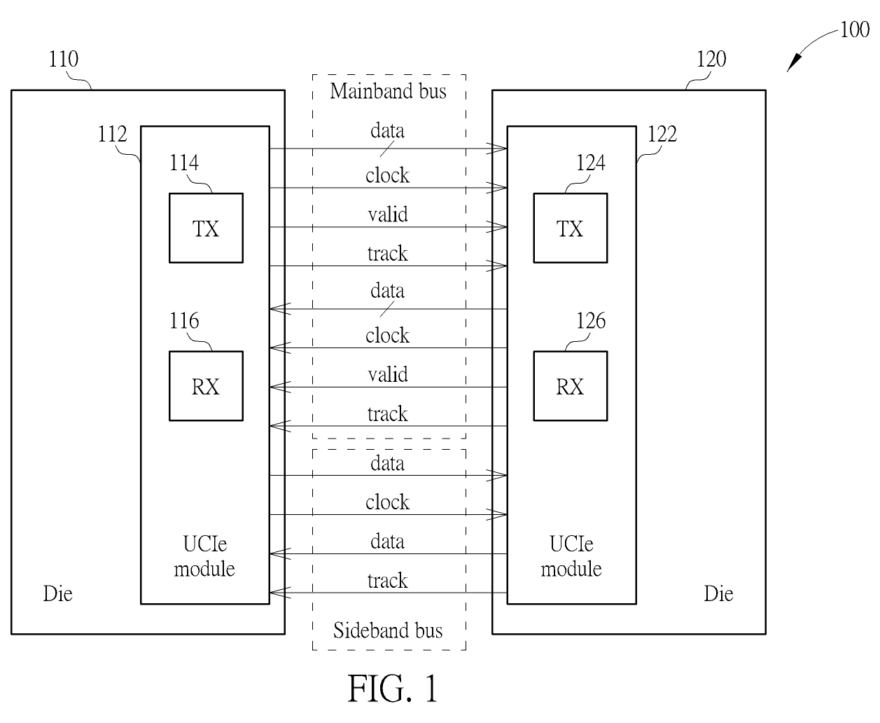

FIG. 1 is a diagram illustrating a package 100 according to one embodiment of the present invention. As shown in FIG. 1, the package 100 comprises at least two dies 110 and 120, wherein the dies 110 and 120 are connected by using multiple connection lines, and the communications between the dies 110 and 120 adhere to Universal Chiplet Interconnect Express (UCIe) specification. The die 110 comprises an UCIe module 112 implemented by hardware circuit, wherein the UCIe module 112 comprises a transmitter 114 and a receiver 116. The die 120 comprises an UCIe module 122 implemented by hardware circuit, wherein the UCIe module 122 comprises a transmitter 124 and a receiver 126. In the embodiment shown in FIG. 1, the dies 110 and 120 are communicated via multiple mainband buses and multiple sideband buses, wherein the mainband buses comprise multiple lanes, and the multiple lanes are used for transmission of multiple data signal (e.g., sixty-four data signals), two clock signals, a valid signal and a track signal; and the sideband buses comprise multiple lanes, and the multiple lanes are used for transmission of data signal and clock signal.

The UCIe specification defines a comprehensive training flow for its mainband interface to establish a robust and reliable high-speed communication link between dies within the package 100. This training process ensures proper signal integrity, clock alignment, and overall link readiness before mission-mode data transfer begins. As described in the background of the present invention, the prior art mainband training flow may have signal integrity issue and longer calibration time. To solve the problems of the prior art mainband training flow, the following embodiment provides a mainband training flow that offers shorter calibration time and improved signal integrity.

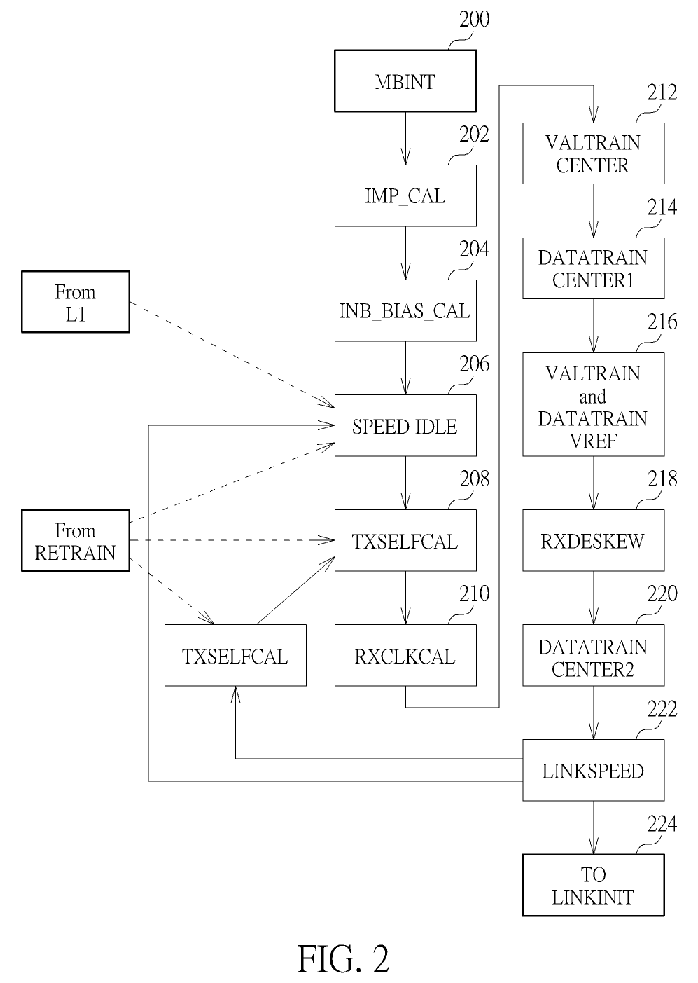

FIG. 2 shows a flowchart of the mainband training flow of the dies 110 and 120 according to one embodiment of the present invention. In the following embodiment, for convenience of illustration, the die 110 serves as the transmitter while die 120 serves as the receiver for the mainband training flow. However, in a complete operational flow, it's also necessary to designate die 120 as the transmitter and die 110 as the receiver to perform the mainband training flow. In Step 200, the dies 110 and 120 complete maintain training initialization. In Step 202, regarding operation “IMP_CAL”, the transmitter 114 within the die 110 performs impedance calibration for impedance match to improve signal integrity. In Step 204, regarding operation “INB_BIAS_CAL”, the receiver 126 calibrates the bias currents or voltages of its internal analog circuits to ensure they are at their optimal operating point. In Step 206, regarding “SPEED IDLE”, during mainband training, the system may enter a specific idle mode where the link remains active, but only transmits particular training patterns or idle mode data, rather than application data. In Step 208, regarding operation “TXSELFCAL”, the transmitter 114 calibrates its internal parameters to enable it to send data with optimal signal quality. In Step 210, regarding operation “RXCLKCAL”, the receiver 126 calibrates its internal clock generation circuit to ensure it can generate appropriate clock signals. In Step 212 – Step 216, regarding operations “VALTRAIN CENTER”, “DATATRAIN CENTER1” and “VALTRAIN and DATATRAIN VREF”, the receiver 126 identifies the center of the eye opening of valid signal, identifies the center of the eye opening of each data signal, optimizes the reference voltage for sampling the valid signal, and optimizes the reference voltage for sampling each of the data signals. In Step 218, regarding operation “RXDESKEW”, the receiver 126 calibrates the time skew between multiple data lanes. In Step 220, regarding operation “DATATRAIN CENTER2”, the receiver 126 employs more refined or iterative training to further optimize the center of the eye opening of each data signal. In Step 222, regarding state “LINKSPEED”, it refers to the final establishment of the negotiated operating speed for the mainband link. In Step 224, the dies 110 and 120 enter the next stage to perform link initialization.

It should be noted that since the content of Steps 200 - 210 and 218 - 224 is well-known to those skilled in the art, and the focus of this embodiment is on Steps 212 - 216, the following description will only detail Steps 212 - 216.

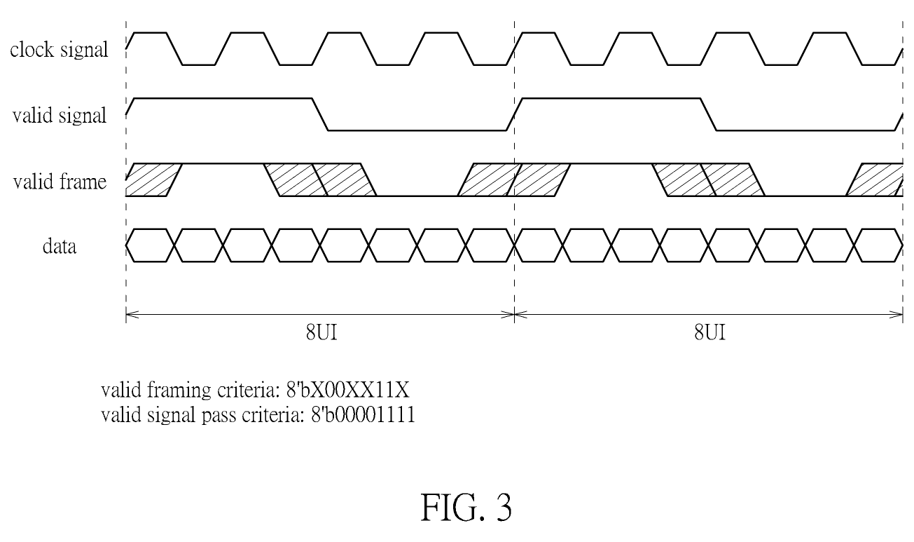

In Step 212, regarding operation “VALTRAIN CENTER”, the receiver 126 identifies the center of the eye opening of valid signal. During Step 212, all of data lanes and the track lane are held low (i.e., the transmitter 114 do not transmit data signals and track signal to the receiver 126), so the signal integrity is not at its worst case. In this embodiment, the receiver 126 distinguishes between the valid signal and valid frame during calibration. Specifically, referring to FIG. 3, the receiver 120 receives a valid signal from the transmitter 114, and uses a clock signal to sample the valid signal to generate sampled result, wherein the valid signal is not scrambled at the transmitter 114, the clock signal may be generated according to clock signal(s) from the transmitter 114, and the valid signal and valid frame shown in FIG. 3 are the same signal. In the UCIe specification, the valid signal has the pattern 8’b00001111, therefore, the receiver 126 sets its valid signal pass criteria to 8'b00001111 to ensure that the sampled result obtained from sampling the valid signal is correct. In addition, to expedite subsequent training of the data signal, the receiver 126 employs a more lenient checking method to determine if a valid frame is effective/valid. Specifically, the receiver 126 can set the valid framing criteria to 8'bX00XX11X. This means that a valid frame is considered effective as long as the sampled results for the middle two bits of the four consecutive '1's in the valid signal are '1', and the sampled results for the middle two bits of the four consecutive '0's are '0'. Only when the valid framing criteria is met can the subsequent data signal training and calibration in Steps 214 and 216 proceed.

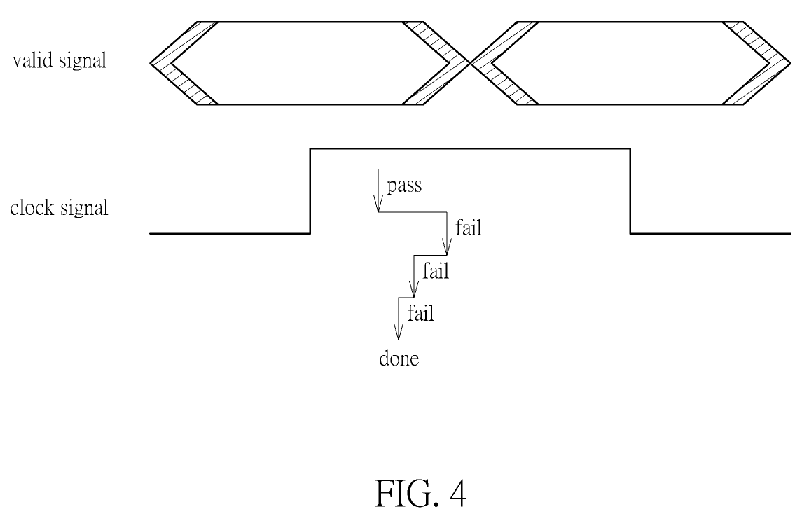

Furthermore, in order to optimize the calibration time, the receiver 126 uses a binary search-like method to find the center of eye opening of the valid signal. Referring to FIG. 4, the receiver 126 uses the clock signal to sample the valid signal to find the right edge of the valid signal; and similarly, the receiver 126 uses the clock signal to sample the valid signal to find the left edge of the valid signal. After the right edge and left edge of the valid signal are determined, the center of eye opening of the valid signal can be obtained. In one embodiment, the phase of the clock signal is adjusted by using a configurable delay line, and the receiver 126 can record the delay codes corresponding to the right edge and left edge of the valid signal; or the receiver 126 can record the calculated delay code corresponding to the center of the valid signal.

In order to optimize time efficiency, the reference voltage for sampling the valid signal is not calibrated immediately after Step 212. In one embodiment, the calibration of the reference voltage for sampling the valid signal is performed with the calibration of the reference voltages for sampling the data signals in Step 216.

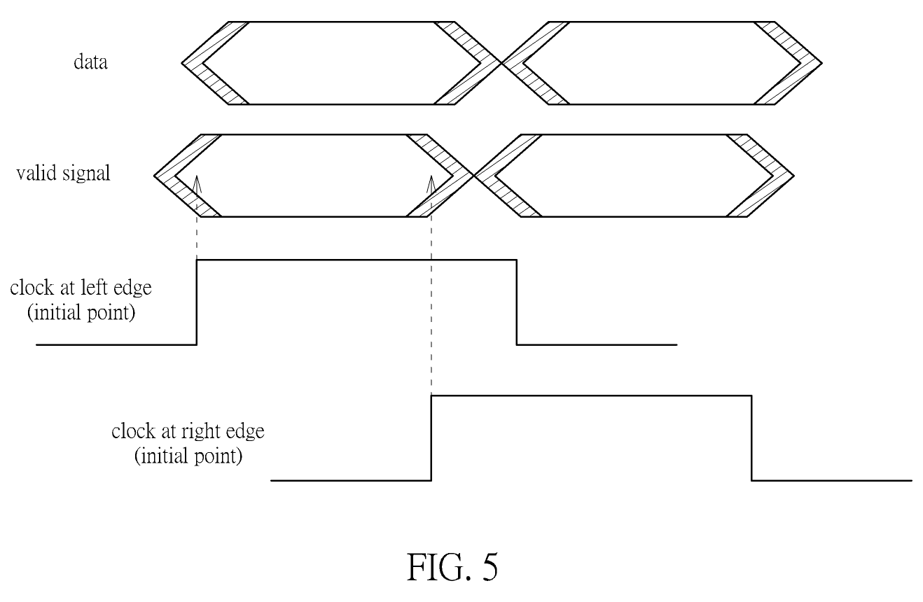

In Step 214, when the valid framing criteria is met, the receiver 126 identifies the center of the eye opening of each of data signals and valid signal. Specifically, the receiver 126 receives data signals (e.g., sixty-four data signals) and valid signal from the transmitter 114. In this embodiment, the data signals generated by the transmitter 114 have LFSR pattern, and considering the worst-case scenario, the valid signal generated by the transmitter 114 also has LFSR pattern. Referring to FIG. 5, the receiver 126 refers to the calibration result of Step 212 to determine an initial point (initial phase) of clock signal for determining left edges of the data signals and valid signal, and the receiver 126 refers to the calibration result of Step 212 to determine an initial point (initial phase) of clock signal for determining right edges of the data signals and valid signal. Then, the receiver 126 sweeps the delay codes of the delay line, to use the clock signal with different phases to sample the data signals and valid signal to determine the right edge and left edge of each of the data signals and valid signal. After the right edge and left edge of each of the data signals and valid signal is determined, the centers of eye opening of these signals can be obtained.

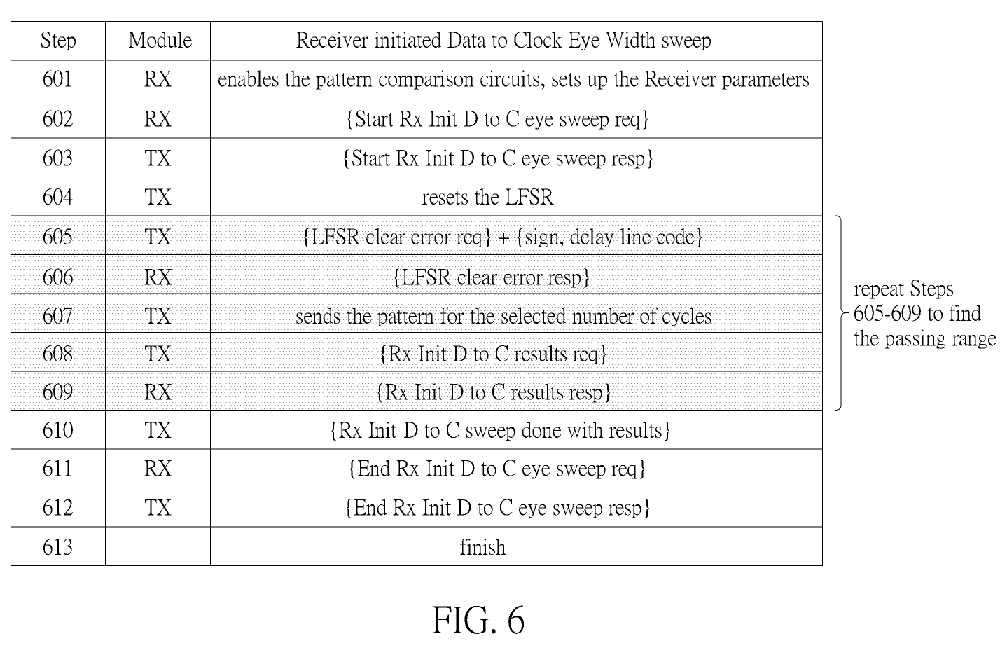

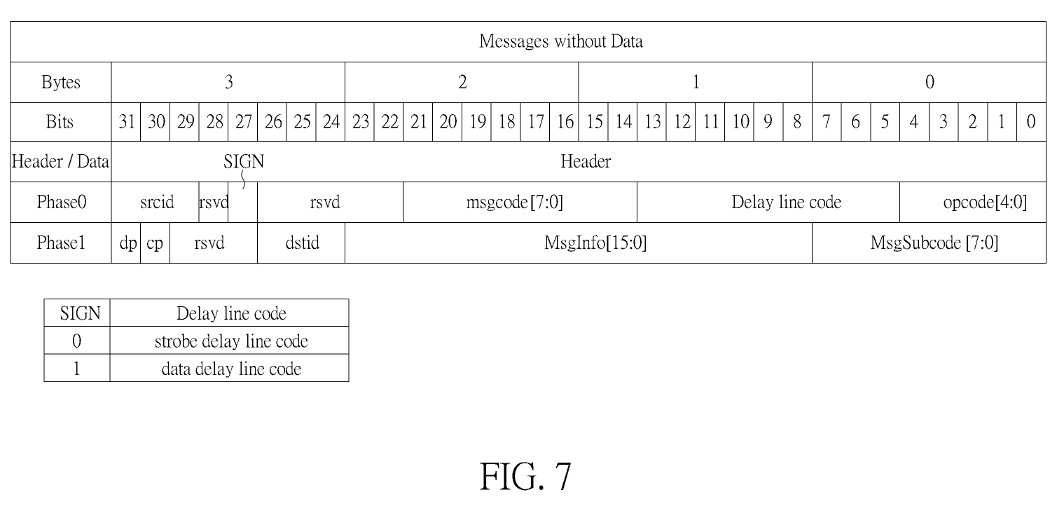

In Step 216, when the valid framing criteria is met, the receiver 126 calibrates the reference voltages for sampling the valid signal and the data signals, respectively. Specifically, the receiver 126 receives data signals (e.g., sixty-four data signals) and valid signal from the transmitter 114. In this embodiment, the data signals generated by the transmitter 114 have LFSR pattern, and considering the worst-case scenario, the valid signal generated by the transmitter 114 also has LFSR pattern. Regarding the operation of the Step 216, a receiver initiated data to clock eye width sweep is performed, and the receiver 126 initiates the data to clock training on all lanes at as single phase interpolator (PI) phase. Refer to FIG. 6, in Step 601, the receiver 126 enables its internal pattern comparison circuit, and sets up the receiver parameters, wherein the comparison circuit is configured to compare the received signals from the transmitter 114 with the locally generated expected pattern. In Step 602, the receiver 126 sends a request to the transmitter 114, to request to start the receiver initiated data to clock eye sweep, wherein this request is a sideband message. In Step 603, the transmitter 114 sends a response to the receiver 126, to respond the request to start the receiver initiated data to clock eye sweep, wherein this response is a sideband message. In Step 604, the transmitter 114 resets the LFSR circuit (i.e., resets the scrambler). In Step 605, the transmitter 114 sends a LFSR clear error request to the receiver 126, to request the receiver 126 to reset its LFSR circuit and clear the prior comparison result, wherein the LFSR clear error request is a sideband message. In addition, message of the LFSR clear error request also includes current PI phase set by the transmitter 114. Specifically, referring to a format of the message without data defined in UCIe specification in FIG. 7, the transmitter 114 uses the reserved fields to add the sign bit and delay code served as current PI phase. In this embodiment, if the sign bit is “0”, the delay line code indicates a strobe delay line code (i.e., the phase of the clock signal); and if the sign bit is “1”, the delay line code indicates a data delay line code (i.e., the phase of the data signal).

It is noted that the other fields of the message shown in FIG. 7 are well-known to those skilled in the art, so the detailed description about these fields are omitted here.

In Step 606, the receiver 126 sends a LFSR clear error response to the transmitter 114, to notify that the LFSR circuit has been reset.

In Step 607, the transmitter 114 starts to send the data signals (e.g., sixty-four data signal) and the valid signal with LFSR pattern to the receiver 126, for the selected number of cycles. The receiver 126 uses the clock signal to sample the received data signals and valid signal from the transmitter 114 to generate the sampled results, wherein the bit values of the sampled results are determined by using a reference voltage, that is the bit value “1” indicates that a voltage level of the data signal or valid signal is greater than the reference voltage, and the bit value “0” indicates that a voltage level of the data signal or valid signal is not greater than the reference voltage. Then, the receiver 126 compares the sampled results within the locally generated expected pattern (locally generated LFSR pattern) to generate the comparison results. The comparison results indicate if sampled results generated by sampling the received data signals and valid signal are correct.

In Step 608, the transmitter 114 sends a request to the receiver 126, to request the receiver initiated data to clock results, wherein this request is a sideband signal.

In Step 609, the receiver 126 sends a response to the transmitter 114, to respond the comparison results serving the receiver initiated data to clock results to the transmitter 114.

It is noted that Steps 605 - 609 are repeatedly executed. This means the sign bit and delay line code transmitted by transmitter 114 in Step 605 are continuously varied until the passing range of the PI phase (i.e., the comparison results mentioned in Step 607 are correct) can be determined.

In Step 610, the transmitter 114 sends the receiver initiated data to clock sweep done with results to the receiver 126. In addition, because the receiver 126 have received multiple sign bits and delay line codes in Step 605, and already knows the comparison result in Step 607 corresponding to the each combination of sign bit and delay line code is passed or failed, the receiver 126 can calculate the eye width of each of the data signals and valid signal by its own, and does not need to receive the eye width information from the transmitter 114.

In Step 611, the receiver 126 sends a request to end receiver initiated data to clock eye sweep to the transmitter 114. In Step 612, the transmitter 114 sends a response of to the receiver 126. In Step 613, the receiver initiated data to clock eye width sweep is finished.

It noted that the above-mentioned Steps 601 – 612 are executed when a single reference voltage is applied. The Steps 601 – 612 can be perform many times by using different reference voltages, to obtain information about passing ranges of PI phase, eye widths of data signals and valid signal corresponding to different reference voltages. This information can be used for calibrating the reference voltage in the receiver 126.

In light of above, in the mainband training flow of the present invention, by employing a more lenient checking method to determine if a valid frame is effective/valid, the dies 110 and 120 can identify the center of the eye opening of each of data signals and valid signal simultaneously, and can optimize the reference voltages for sampling the valid signal and the data signals simultaneously, to improve time efficiency. In addition, by controlling the transmitter to send the sign bit and delay line code to the receiver during a receiver initiated data to clock eye width sweep, the receiver can calculate the eye width of each of the data signals and valid signal by itself, to improve the efficiency of the receiver during a receiver initiated data to clock eye width sweep.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mainband training method between a transmitter within a first die and a receiver within a second die, comprising:
setting, by the receiver, a valid framing criteria and a valid signal pass criteria, wherein the valid framing criteria is more lenient than the valid signal pass criteria;
receiving, by the receiver, a valid signal from the transmitter, and determining if the valid signal satisfies the valid framing criteria; and
if the valid signal satisfies the valid framing criteria, identifying, by the receiver, centers of eye opening of multiple data signal and the valid signal.

2. The mainband training method of claim 1, wherein the valid signal pass criteria is 8'b00001111, and the valid framing criteria is 8'bX00XX11X.

3. The mainband training method of claim 1, wherein the step of if the valid signal satisfies the valid framing criteria, identifying, by the receiver, the centers of eye opening of the multiple data signal and the valid signal comprises:
if the valid signal satisfies the valid framing criteria, simultaneously identifying, by the receiver, the centers of eye opening of the multiple data signal and the valid signal.

4. The mainband training method of claim 3, wherein the multiple data signals and the valid signal generated by the transmitter have linear feedback shift register (LFSR) pattern.

5. The mainband training method of claim 1, further comprising:
after identifying, by the receiver, the centers of eye opening of the multiple data signal and the valid signal, simultaneously calibrating, by the receiver, multiple reference voltages used for sampling the multiple data signal and the valid signal.

6. The mainband training method of claim 5, wherein the multiple data signals and the valid signal generated by the transmitter have linear feedback shift register (LFSR) pattern.

7. The mainband training method of claim 5, wherein the step of simultaneously calibrating, by the receiver, the multiple reference voltages used for sampling the multiple data signal and the valid signal comprises:
performing a receiver initiated data to clock eye width sweep operation:
for one of the multiple reference voltages:
(i) sending, by the transmitter a LFSR clear error request with a phase interpolator (PI) information to the receiver;
(ii) sending, by the receiver, a LFSR clear error response to the transmitter, to notify that a LFSR circuit has been reset;
(iii) sending, by the transmitter, the multiple data signals and the valid signal to the receiver; and
(iv) sampling, by the receiver, the multiple data signals and the valid signal to generate sampled results, and comparing the sampled results with locally generated expected pattern to generate comparison results, wherein the comparison results indicate if sampled results generated by sampling the received data signals and valid signal are correct.

8. The mainband training method of claim 7, wherein the PI information comprises a sign bit and a delay line code, the sign bit indicates whether the delay line code corresponds to a strobe delay line code or a data delay line code.

9. The mainband training method of claim 7, further comprising:
repeatedly executing steps (i) – (iv) with different PI information until a passing range of the PI phase is determined.

10. The mainband training method of claim 9, further comprising:
after the passing range of the PI phase is determined, calculating, by the receiver, an eye width of each of the multiple data signals and the valid signal.

11. The mainband training method of claim 1, wherein the mainband training method adheres to Universal Chiplet Interconnect Express (UCIe) standard.

12. A package, comprising:
a first die comprising a transmitter;
a second die comprising a receiver;
wherein the first die and the second die performs a mainband training method, and the mainband training method comprises:
setting, by the receiver, a valid framing criteria and a valid signal pass criteria, wherein the valid framing criteria is more lenient than the valid signal pass criteria;
receiving, by the receiver, a valid signal from the transmitter, and determining if the valid signal satisfies the valid framing criteria; and
if the valid signal satisfies the valid framing criteria, identifying, by the receiver, centers of eye opening of multiple data signal and the valid signal.

13. The package of claim 12, wherein the valid signal pass criteria is 8'b00001111, and the valid framing criteria is 8'bX00XX11X.

14. The package of claim 12, wherein the step of if the valid signal satisfies the valid framing criteria, identifying, by the receiver, the centers of eye opening of the multiple data signal and the valid signal comprises:
if the valid signal satisfies the valid framing criteria, simultaneously identifying, by the receiver, the centers of eye opening of the multiple data signal and the valid signal.

15. The package of claim 12, further comprising:
after identifying, by the receiver, the centers of eye opening of the multiple data signal and the valid signal, simultaneously calibrating, by the receiver, multiple reference voltages used for sampling the multiple data signal and the valid signal.
